(19) United States
(12) Patent Application Publication
(10) Pub. No.: US 2002/0030583 A1
(43) Pub. Date: Mar. 14, 2002

(54) Door control device based on non-touch non-contact charging method

(76) Inventors: Jin Jang, Kwangju-Si (KR); Hong Kim, Chungcheongnam-Do (KR)

Correspondence Address: JACOBSON HOLMAN PLLC, 400 SEVENTH STREET N.W., SUITE 600, WASHINGTON, DC, 20004, US

(21) Appl. No.: 09/891,254

(22) Filed: Jun. 27, 2001

(30) Foreign Application Priority Data
Sep. 8, 2000 (KR) 2000-53438

(51) Int. Cl. G05B 19/00

(52) U.S. Cl. 340/5.53

(57) ABSTRACT

Provided is a door control device based on non-touch non-contact charging method, which is applied to a home automation system including an intercom for allowing communication between a visitor and an occupant. The door control device comprises an interior unit and an exterior unit located at inside and outside the door, respectively, without using electric wires. The interior unit includes a first converter for converting a first AC signal having a first frequency into a DC signal, a second converter for converting the DC signal into a second AC signal having a second frequency in which a predetermined control signal is inserted, and a primary transformer to which the second AC signal with the control signal is applied. The exterior unit includes a secondary transformer to which the second AC signal with the control signal from the primary transformer is applied as an induced current, a rectifier for separating the control signal from the signal provided from the secondary transformer, and simultaneously rectifying the same, a charger to which the rectified signal is provided, and a microprocessor to which the separated control signal is provided for analyzing the control signal and providing a door lock with a door open signal according to the analyzed result.

### BACKGROUND OF THE INVENTION

1. Field of the Invention

The present invention relates to a door control device based on a non-touch non-contact charging method, which can be widely used for doors in an apartment or other similar facilities, and more particularly, to a door control device in which an interior unit and an exterior unit of the door don't contact each other to control door locking and unlocking, and a call connection is automatically established to a predetermined telephone if a doorbell is rung during the occupant's absence, so that the occupant(s) of the apartment or building, can communicate with the visitor, even in a remote site.

2. Description of the Related Art

In general, a main key is basically installed on the front door of an apartment or other similar facilities, and an extra key may be further installed thereon by a user, so that the locked state of the door can be secured during the user's absence.

Recently, door locking and unlocking methods using an encryption number, rather than an extra key, or using a fingerprint identification algorithm have been proposed for use.

According to the conventional fingerprint identification type door locking device, battery consumption is large, which makes it difficult to provide additional functions. Also, since it is quite difficult to install such a device and power supply must be connected, the device can be restrictedly applied only to newly constructed buildings or apartments. In the case of using power supply, rather than wasting batteries, the door has a bad appearance due to its difficult wiring work.

Also, even if the fingerprint identification type door locking device does not operate properly due to failure in fingerprint identification, there is no way to overcome the problem. Further, in existing apartment front doors, since the door itself moves according to its opening or closure, wiring is quite a difficult work, resulting in impossible provision of additional functions.

### SUMMARY OF THE INVENTION

It is an object of the present invention to provide a door control device which can be applied to a home automation system including an intercom for allowing communication between the visitor and the occupant and a door control device for controlling the door to be unlocked by pressing a button and can open/close the door by a non-touch non-contact charging method.

It is another object of the present invention to provide a door control device in which a fingerprint identification unit is installed on the exterior plate of the door to lock and/or unlock the door by identifying the fingerprint of a specified person.

It is still another object of the present invention to provide a door control device which can manage a visitor even in a remote site by allowing communication between the visitor and an occupant during the occupant's absence.

To accomplish the above objects of the present invention, there is provided a door control device based on non-touch non-contact charging method, which is applied to a home automation system including an intercom for allowing communication between a visitor and an occupant, said door control device comprising an interior unit and an exterior unit located at inside and outside the door, respectively, without using electric wires, wherein the interior unit includes a first converter for converting a first AC signal having a first frequency into a DC signal, a second converter for converting the DC signal into a second AC signal having a second frequency in which a predetermined control signal is inserted, and a primary transformer to which the second AC signal with the control signal is applied, and the exterior unit includes a secondary transformer to which the second AC signal with the control signal from the primary transformer is applied as an induced current, a rectifier for separating the control signal from the signal provided from the secondary transformer, and simultaneously rectifying the same, a charger to which the rectified signal is provided, and a microprocessor to which the separated control signal is provided for analyzing the control signal and providing a door lock with a door open signal according to the analyzed result.

Also, according to the present invention, a fingerprint identification unit is provided on the exterior plate of the door and an encryption number pressing board is provided on the interior plate of the door, thereby permitting a specified person to open and/or close the door.

### BRIEF DESCRIPTION OF THE DRAWINGS

The above object and advantages of the present invention will become more apparent by describing in detail a preferred embodiment thereof with reference to the attached drawings in which:

FIG. 1 is a block diagram of a door control device based on a non-touch non-contact charging method according to an embodiment of the present invention;

FIG. 2 is a detailed block diagram of interior and exterior units shown in FIG. 1; and

FIG. 3 is a schematic diagram of a door control device based on a non-touch non-contact charging method according to another embodiment of the present invention.

### DESCRIPTION OF THE PREFERRED EMBODIMENT

A preferred embodiment of the present invention will now be described in detail with reference to the accompanying drawings.

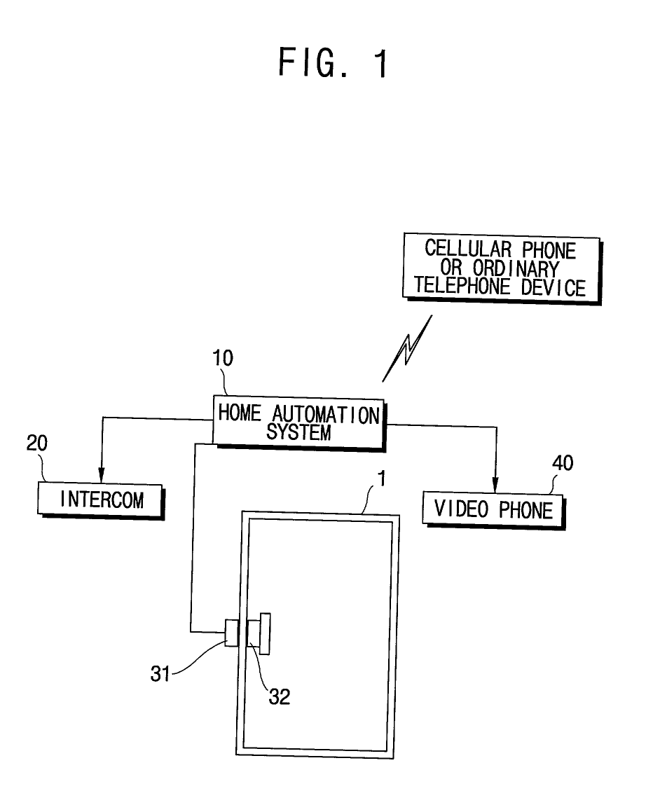

Referring to FIG. 1, a home automation system 10 includes an intercom 20 for allowing communication between the visitor and the occupant, a door control device comprising an interior unit 31 and an exterior unit 32 for controlling door locking and unlocking, a video phone 40 connected to the intercom 20 for allowing the identity of the visitor, thereby opening/closing the door and so on.

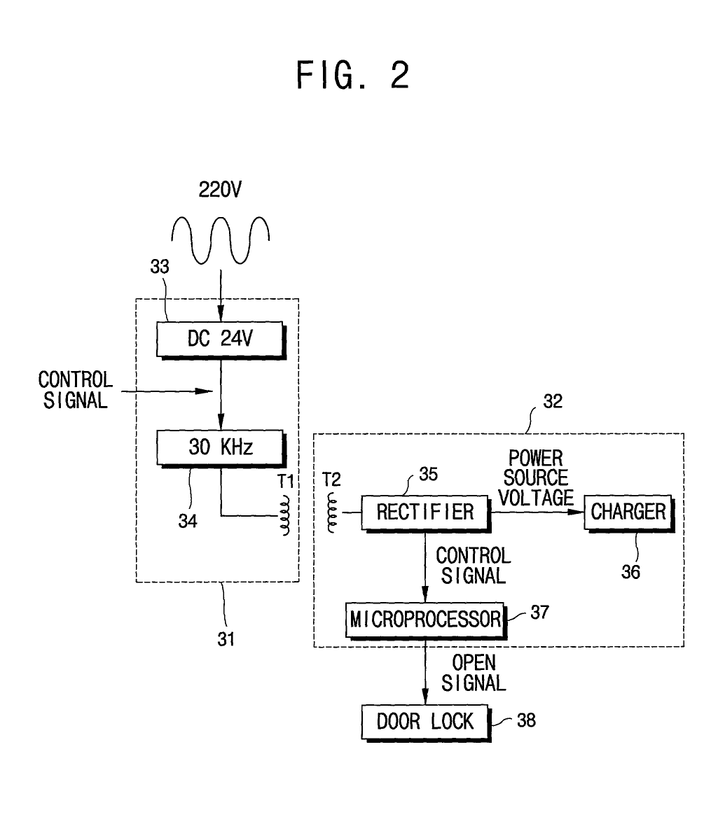

The door control device according to the present invention is characterized by its operation by a non-touch non-contact charging method. Referring to FIG. 2, primary and secondary transformers T1 and T2 in the interior and exterior units 31 and 32 of the door, respectively, operate without using electric wires not to contact each other, for controlling door locking and unlocking.

In more detail, the interior unit 31 of the door control device includes a first converter 33, a second converter 34 and the primary transformer T1. The exterior unit 32 of the door control device includes the secondary transformer T2, a rectifier 35, a charger 36 and a microprocessor 37.

In other words, if the button of the home automation system 10 is pressed to seek access inside, the first converter 33 converts an AC signal e.g., AC 220V, 60 Hz into a DC signal, e.g., DC 24V. The second converter 34 converts the DC signal into another AC signal having a particular frequency e.g., 30 KHz in which a pre-specified control signal is inserted, and applies the AC signal with the control signal inserted therein to the primary transformer T1.

The AC signal applied to the primary transformer T1 is provided to the exterior unit 32 located outside the door without contacting with the interior unit 31. The operation of the exterior unit 32 will now be described in detail.

The AC signal applied to the primary transformer T1 is provided to the secondary transformer T2 as an induced current. The rectifier 35 separates the control signal from the signal provided from the secondary transformer T2, and simultaneously rectifies the same. The rectified signal is provided to the charger 36 and the separated control signal is provided to the microprocessor 37. The microprocessor 37 analyzes the control signal and provides a door lock 38 with a door open signal according to the analyzed result, thereby opening the door.

Here, since devices for releasing a locked state by means of a predetermined signal have been well known and used, a detailed explanation thereof will be avoided.

Meanwhile, since the fingerprint identification algorithm and/or device have been widely used, it is preferred to identify a visitor more accurately by applying the fingerprint identification algorithm and/or device to the door, instead of an extra key.

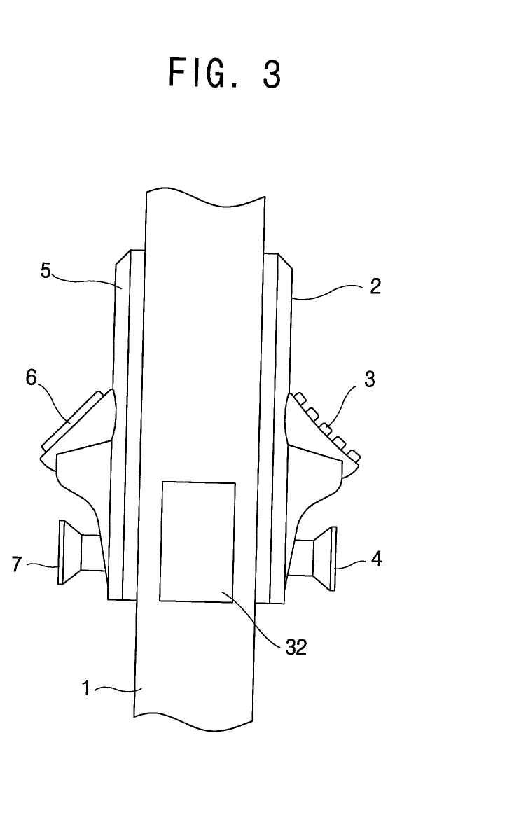

In other words, the home automation system 10 stores users' fingerprint data in advance. As shown in FIG. 3, a fingerprint identification unit 6 for inputting a visitor's fingerprint is mounted on the exterior plate 5 of the door 1. When the visitor's fingerprint is input to the fingerprint identification unit 6, the home automation system 10 compares the visitor's fingerprint with the stored users' fingerprint data and operates the door control device 31 and 32 only if they are identical.

Here, operating the door control device means that the interior unit 31 of the door control device converts an AC signal e.g., AC 220V, 60 Hz into a DC signal, e.g., 24V and then the DC signal into another AC signal having a particular frequency e.g., 30 KHz in which a pre-specified control signal is inserted, and applies the AC signal with the control signal to the primary transformer T1, like the case where a button of the home automation system 10 is pressed for unlocking the door, as described above.

It is preferred that the fingerprint identification unit 6 is constructed such that it can operate by a power source charged into the charger 36.

That is, according to the present invention, since the fingerprint identification unit 6 is mounted on the exterior plate 2 of the door 1 to identify the fingerprint of a specified person, the door 1 would not be opened/closed by a person other than the specified person.

Also, to date there was no way to identify the visitor, resulting in the user's inconvenience. Accordingly, it is preferred that a function to identify the visitor even during the occupant's absence is further adopted.

In other words, the home automation system 10 is connected to the external telephone line and stores telephone numbers entered by an occupant, which can be reached with him/her outside. If a visitor presses the intercom 20 and the intercom 20 rings 3 times or so, the home automation system 10 is automatically connected to the pre-entered telephone number to establish a call connection. If the call connection is successfully made, the home automation system 10 connects the intercom 20 with the external telephone, thereby allowing communication between the visitor and occupant even while he/she is away from home. If a pre-specified telephone key signal is applied to the home automation system 10 from the occupant outside though the external telephone line, the home automation system 10 operates the door control device 31 and 32 to control the door to be opened according to the telephone key signal.

Here, the cellular phones as well as the ordinary telephone device can be used as the occupant's telephone since the home automation system 10 is connected to the external telephone line such as a public line, an internet line and so on.

Further, it is preferred that a means through which an encryption number can be entered is further adapted so that a door unlocking can be blocked for the occupant's security inside. In other words, if a user (an occupant) enters the encryption number, the door 1 is locked to the door frame by a driving motor (not shown) installed at the interior side the door 1 so that the door 1 will not open even by rotating the exterior lever 7 from the exterior side of the door 1.

For this purpose, an encryption number pressing board 3 through which an encryption number can be entered is further mounted on the upper portion of an interior lever 4 on the interior plate 2 of a door 1, the encryption number pressing board 3 having a release button and an encryption number input button. That is, when the user enters an encryption number using the encryption number pressing board 3 and a release by the release button is not made, the AC signal is not applied to the primary transformer T1, thereby being impossible to open the door 1 irrespective of the function of the fingerprint identification unit 6.

As described above, according to the present invention, since the interior and exterior units of the door is implemented based on a non-tough non-contact charging method, wiring becomes simple and its failure rate is decreased. Also, in the case of further including the fingerprint identification unit, the accurate identification of any visitors is possible. Further, since a home automation system is automatically connected to a particular telephone if a bell is rung during the occupant's absence, the occupant outside can unlock the door after communication with the visitor.

What is claimed is:

1. A door control device based on non-touch non-contact charging method, which is applied to a home automation system including an intercom for allowing communication between a visitor and an occupant, said door control device comprising an interior unit and an exterior unit located at inside and outside the door, respectively, without using electric wires,
wherein the interior unit includes a first converter for converting a first AC signal having a first frequency into a DC signal, a second converter for converting the DC signal into a second AC signal having a second frequency in which a predetermined control signal is inserted, and a primary transformer to which the second AC signal with the control signal is applied, and the exterior unit includes a secondary transformer to which the second AC signal with the control signal from the primary transformer is applied as an induced current, a rectifier for separating the control signal from the signal provided from the secondary transformer, and simultaneously rectifying the same, a charger to which the rectified signal is provided, and a microprocessor to which the separated control signal is provided for analyzing the control signal and providing a door lock with a door open signal according to the analyzed result.

2. The door control device according to claim 1, further comprising a fingerprint identification unit mounted on the exterior plate of the door and operated by the voltage charged to the charger, for identifying the visitor's fingerprint by comparing the visitor's fingerprint inputted to the fingerprint identification unit with pre-stored fingerprint data in the home automation system to then control the interior and exterior units.

3. The door control device according to claim 1, wherein the home automation system is connected to the external telephone line and stores telephone numbers entered by an occupant, which can be reached with him/her outside, if the intercom rings a predetermined times or so, the home automation system is automatically connected to the pre-entered telephone number to establish a call connection and if a pre-specified telephone key signal is applied to the home automation system from the occupant outside though the external telephone line, the home automation system operates the interior and exterior units.

4. The door control device according to claim 1, further comprising an encryption number pressing board mounted on the interior plate of the door, the encryption number pressing board having a release button and a encryption number input button, wherein when the user enters an encryption number using the encryption number pressing board and a release by the release button is not made, the AC signal is not applied to the primary transformer.
